(19) United States
(12) Patent Application Publication
(10) Pub. No.: US 2003/0227902 A1
(43) Pub. Date: Dec. 11, 2003

(54) System for connecting computer-requested telephone calls using a distributed network of gateways

(76) Inventor: Benjamin Lindquist, Tallahassee, FL (US)

Correspondence Address: Benjamin Lindquist, 1114-V Thomasville Rd., Tallahassee, FL, 32303, US

(21) Appl. No.: 10/163,938

(22) Filed: Jun. 6, 2002

(51) Int. Cl. H04L 12/66

(52) U.S. Cl. 370/352; 370/401

(57) ABSTRACT

A system for connecting and completing telephone calls over the Public Switched Telephone Network (PSTN) at the request of a client computer is disclosed. The system includes a call table (calltable), an application server (appserver) which accesses the calltable and communicates with the client computer, and a telephony gateway (gateway) which makes the calls, polling the appserver to receive call requests (callrequests) and report completions of callrequests. A callrequest is a data record including two phone numbers, a status, and a unique identifier, and optionally including a maximum duration. Upon receiving a callrequest from the appserver, the gateway uses its connection to the PSTN to make two phone calls—one to each phone number contained in the callrequest; it then bridges the separate calls together, and allows them to remain connected until either party terminates their call, or a maximum duration is reached. Upon termination of the callrequest, the gateway reports the actual connection duration back to the appserver, and the appserver updates the calltable. Multiple gateways may participate in the system and may be geographically dispersed. The advantage of this system is that PSTN calls can be initiated by any computer which is able to communicate with the appserver. When the computer requesting a call is associated with an Internet website with access to a database of users, the system provides a real-time communication solution allowing those users to talk to each other on the phone without revealing their phone numbers to each other.

### BACKGROUND OF THE INVENTION

With the rapid growth of the Internet, person-to-person communication often takes place between people who are anonymous to one another. This invention allows the communication to shift to the telephone while remaining anonymous, and also allows the communication to be initiated within the context of a website or other computer application that a caller may be using.

An alternative approach to providing this type of service can be found in U.S. Pat. No. 6,188,683 (System and method for establishing long distance voice communications using the Internet), assigned to Softalk, Inc. Softalk's system utilizes toll switches to make long distance phone calls and conference them together; the means of controlling the toll switches is a computer which is interfaced to the switch, and can respond to requests received from another computer via a data network. My system uses “telephony gateways” instead of toll switches interfaced to computers. A telephony gateway, as defined for the purpose of my system, is a computer containing both a data network interface (such as an Ethernet card) and a circuit-switched telephony interface, enabling the computer to receive and respond to requests from other computers which instruct it to make phone calls on the PSTN and bridge them together. The call bridging (similar to conferencing) takes place within the telephony gateway hardware, not within a toll switch.

The telephony gateways act as clients of the appserver(s), polling them for callrequests to handle (all communication between a telephony gateway and an appserver is initiated by the telephony gateway). This allows for massive scaling of the system through the establishment of groups of telephony gateways in many different geographical locations, while keeping administrative overhead to a minimum because the telephony gateways need not be defined or known individually within the database or appservers. This results in a lower operational cost as compared to Softalk's system, in which a call request is “forwarded” to a computer capable of handling it. In order to forward information, a sending computer must have a defined and maintained address for the receiving computer. A distributed collection of small devices can also be expanded more rapidly, and in smaller increments, than a hierarchically connected system of more expensive, higher-capacity nodes, allowing for demand-based growth of the infrastructure.

### BRIEF SUMMARY OF THE INVENTION

The object of this invention is to provide a technical service to be integrated with websites and other computer systems via the Internet, to provide them with the ability to initiate telephone calls that connect their customers or users together. This can provide users the ability to communicate when not at their computers, by using their cellphones; provides them with guaranteed anonymity on the phone; and provides them with the convenience of contacting someone via the phone by clicking on a link.

### TECHNICAL FIELD

This invention relates to the integration of the public switched telephone network with data networks such as the Internet, by allowing computers on the Internet to cause person-to-person phone calls to take place without revealing phone numbers to either party.

### DETAILED DESCRIPTION OF THE INVENTION

Implementation of the system begins with establishment of a database server containing a table for storing callrequest records and a table for storing client account records. In the preferred embodiment, this is any SQL relational database server. The callrequest table can be created using the following SQL statement:

Create table callrequests (id int, create_time timestamp, phone1 char(10), phone2 char(10), maxduration int, actualduration int, status char(1), clientid varchar(20), primary key(id));

The client account table can be created using the following SQL statement:

Create table clients (clientid varchar(20), password varchar(20), minutesused int, primary key(clientid));

The next step in the implementation is establishment of an application server with access to the database; in the preferred embodiment the application server is a Java servlet running within any J2EE environment and communicating with the database using JDBC. The servlet in the preferred embodiment is programmed to accept the posting of an XML document via the HTTPS protocol, interact with the database, and respond with another XML document. Two types of document can be posted to the servlet: a call request initiation document and a telephony gateway handshake document.

In the preferred embodiment, a call request initiation document is posted by a client computer (external to the system) in order to cause two phone devices to be connected, and must contain a client id and password, two phone numbers; and, optionally, a maximum duration for the call. An example follows:

```
<CALLREQUEST>
    <CLIENTID>abccorp</CLIENTID>
    <PASSWORD>tkkx8eO</PASSWORD>
    <PHONE1>8885551212</PHONE1>
    <PHONE2>8885551213</PHONE2>
    <MAXDURATION>15</MAXDURATION>
</CALLREQUEST>
```

Upon receipt of a callrequest initiation document, the appserver parses the data out of the XML, validates the clientid and password by looking them up in the client table, and, if the id and password match those of a record in the client account table, inserts a new record into the callrequest table in the database, with a status indicating that the callrequest is unhandled.

The appserver's response to this document can be simply an indication of successful acceptance of the request. In the preferred embodiment, the appserver responds with the unique identifier of the newly created callrequest record.

In the preferred embodiment, the telephony gateway handshake document is posted by a telephony gateway in order to report the durations of completed calls to the appserver and to request new calls to handle. It must contain an element stating the maximum number of callrequests the telephony gateway can currently handle. An example follows:

<HANDSHAKE>

<MAXREQUESTS>10</MAXREQUESTS>
<COMPLETIONS>

<COMPLETION>

<UID>2456</UID>
<DURATION>409</DURATION>
<CLIENTID>abccorp</CLIENTID>

</COMPLETION>
<COMPLETION>

<UID>2459</UID>
<DURATION>18</DURATION>
<CLIENTID>xyzinc</CLIENTID>

</COMPLETION>

</COMPLETIONS>

</HANDSHAKE>

Upon receiving a handshake document, the appserver loops through the “COMPLETION” records contained in the XML, updating the corresponding callrequest records in the database with new “actualduration” values and statuses indicating that they are complete. The records to update are identified by their “UID” fields. Additionally, for each “COMPLETION” record, the minutesused field of the appropriate client account record is updated with its current value plus the number of minutes the call lasted. In the preferred embodiment, the number of minutes is determined by dividing the “DURATION” XML field by 60 and then rounding up to the nearest integer.

Next, the appserver selects from the database all callrequest records which have an unhandled status, and places up to “MAXREQUESTS” records in a response document to be transmitted back to the telephony gateway. An example response document follows:

<HANDSHAKERESPONSE>

<CALLS>

<CALL>

<PHONE1>8505551212</PHONE1>
<PHONE2>8505551213</PHONE2>
<MAXDURATION>15</MAXDURATION>
<UID>2465</UID>
<CLIENTID>abccorp</CLIENTID>

</CALL>
<CALL>

<PHONE1>8505554444</PHONE1>
<PHONE2>8505556666</PHONE2>
<MAXDURATION>48</MAXDURATION>
<UID>2466</UID>
<CLIENTID>abccorp</CLIENTID>

</CALL>

</CALLS>

</HANDSHAKERESPONSE>

The preferred embodiment of the telephony gateway is an Intel-based PC able to communicate with the appserver using the HTTPS protocol and containing an Intel Dialogic telephony card (model d/240sc-T1) interfaced to a “clearchannel” T1 providing 24 digital channels capable of initiating long distance calls on the PSTN.

The telephony gateway, in the preferred embodiment, runs a Java application which transmits a telephony gateway handshake document to the appserver every 3 seconds, receiving a handshake response document each time. Upon receipt of a handshake response document which contains callrequests to be handled, the Java application runs one instance of a simple callrouting program for each callrequest, and waits for output from the programs. The callrouting programs are invoked as separate processes using the “exec” method of the Java “Runtime” object, and are passed two phone numbers and an optional maximum duration in the form of command-line parameters.

The callrouting program is a C program which uses the Dialogic API to instruct the Dialogic card to make two phone calls and bridge them together. The program times the call once the bridging is accomplished, limiting it to a maximum duration if such a value has been passed to it, and outputting the actual duration of the call upon completion.

Upon receipt of output from an instance of the callrouting program, the Java program places the UID and actual duration (expressed in seconds) of the call it handled into a queue in memory, for transmittal to the appserver as a part of the next telephony gateway handshake message.

### DESCRIPTION OF THE DRAWING

FIG. 1 is a diagram depicting the major components of the system, their network connections, and the flow of a phone call from initiation by a client computer to update of the database with the actual duration. The solid lines in the diagram represent network connections, and the dashed lines represent steps in the process flow. The following flow steps are depicted:

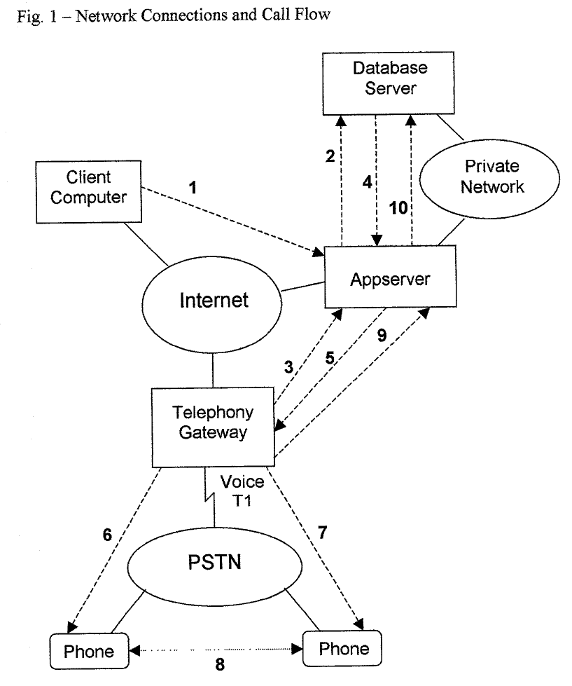

1. A client computer contacts the appserver using the Internet, and requests that a call take place.

2. The appserver communicates with the database to validate the client, and record the callrequest.

3. The telephony gateway contacts the appserver using the Internet, and requests calls to handle.

4. The appserver retrieves the unhandled callrequest from the database.

5. The appserver transmits the callrequest to the telephony gateway.

6. The telephony gateway uses one channel (line) of a voice T1 to place a phone call to the first phone number contained in the callrequest.

7. The telephony gateway uses a second channel to place a call to the second number contained in the callrequest.

8. The two phone calls are bridged within the telephony gateway, and become one phone call between the two phone numbers.

9. Upon completion of the call, the telephony gateway reports the actual duration to the appserver.

10. The appserver updates the callrequest and client account records in the database.

I claim:

1. An apparatus allowing a client computer to cause communications to be established between two devices connected to the PSTN and identified by phone numbers, comprising:
a) A call table allowing the storage and update of callrequests, each callrequest being a data record containing two phone numbers, a unique identifier, an optional maximum duration, an actual duration, a status, and a creation timestamp. The set of valid values for the status field contains at least:
an “unhandled” status indicating that the call has not been handed to a telephony gateway
a “handled” status indicating that the call has been handed to a telephony gateway, but has not been completed
a “completed” status indicating that the telephony gateway that handled the call has completed the call and reported back the duration
b) An application server having access to the calltable and accessible to the client computer via a data network and programmed to validate a client computer using a username (clientid) and password supplied by the client computer, and to insert callrequests into the calltable at the request of validated client computers.
c) An application server (possibly the same computer as the server described above) having access to the calltable and accessible to the gateway and programmed to:
Retrieve callrequests having “unhandled” status from the calltable and report them to the gateway, at the request of the gateway, and set the status of reported callrequests to “handled”.
Update callrequests in the calltable with duration information reported by the gateway, and with a “completed” status.
Update client account records with the cumulative total time of calls requested by the respective clients.
d) A telephony gateway with data network access to the appserver and with multiple channels of network access to the PSTN, and programmed to:
Periodically communicate with, or poll, the appserver, reporting the number of callrequests it can currently handle, along with the durations of callrequests that have been completed; and receiving new callrequests.
For each new callrequest received, make two phone calls using available PSTN channels and bridge the calls together within the interface hardware.
Time each connected callrequest, terminating both constituent calls if the callrequest reaches its maximum duration or if the party at the end of one of the constituent calls terminates it.

2. The system described in claim 1, where multiple telephony gateways poll one or more appservers, each appserver having access to the database.
